(19) United States
(12) Patent Application Publication
(10) Pub. No.: US 2004/0203797 A1
(43) Pub. Date: Oct. 14, 2004

(54) Method and apparatus for communications using distributed services in a mobile ad hoc network (MANET)

(76) Inventor: Jeremy Burr, Portland, OR (US)

Correspondence Address: INTEL CORPORATION, P.O. BOX 5326, SANTA CLARA, CA, 95056-5326, US

(21) Appl. No.: 10/236,293

(22) Filed: Sep. 5, 2002

(51) Int. Cl. H04Q 7/20

(52) U.S. Cl. 455/445; 455/410; 455/414.1

(57) ABSTRACT

A wireless device may share one or more of its resources to other devices within a mobile ad-hoc network (MANET) which share the same association. The device may share its processing unit capability by performing tasks on behalf of the other devices. The device may share its memory unit by storing data on behalf of the other devices. The device sharing its resources and the other devices using the shared resources may dynamically perform updates to reflect changes to the MANET.

### RELATED APPLICATION DATA

This application is related to U.S. patent application Ser. No. 09/773,682, titled “ENABLING RESTRICTED COMMUNICATIONS BETWEEN A PLURALITY OF USERS”, filed Jan. 31, 2001, and to U.S. patent application Ser. No. 09/930,779, titled “METHOD FOR DISCOVERY AND ROUTING USING BUDDY LISTS IN MOBILE AD-HOC NETWORKS”, filed Aug. 15, 2001, and to U.S. patent application Ser. No. 09/948,300, titled “METHOD FOR RESTRICTED COMMUNICATIONS USING BUDDY LISTS IN MOBILE AD-HOC NETWORKS”, filed Sep. 6, 2001, and to U.S. patent application Ser. No. 09/948,270, titled “METHOD FOR DISCOVERY AND ROUTING USING ATTRIBUTES IN MOBILE AD-HOC NETWORKS”, filed Sep. 6, 2001, and to U.S. patent application Ser. No. 09/035,896, titled “METHOD FOR DISCOVERY AND ROUTING WITHIN MOBILE AD-HOC NETWORKS”, filed Oct. 18, 2001, and to U.S. patent application Ser. No. 09/035,463, titled “METHOD FOR DISCOVERY AND ROUTING USING APPLICATION PROGRAMS IN MOBILE AD-HOC NETWORKS”, filed Oct. 18, 2001, and to U.S. patent application Ser. No. 10/183,152, titled “ACTIVE KEY FOR WIRELESS DEVICE CONFIGURATION”, filed Jun. 26, 2002.

### FIELD OF THE INVENTION

The present invention relates to the field of communication, more particularly relating to methods and apparatuses for using distributed services in a network.

### BACKGROUND

Computer systems are becoming increasingly pervasive in our society, including everything from small handheld mobile electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers.

A mobile ad-hoc network (MANET) is an autonomous system of computer systems and associated host computer systems connected by wireless links, the union of which forms an arbitrary graph. In contrast to the typically envisioned computer network, a MANET does not consist of separate server computer systems and client computer systems. The computer systems in MANET are free to move randomly and organize themselves arbitrarily. Each computer system may send its own messages. Each computer system may also function as routers and route messages sent by other computer systems. A MANET may operate as an independent network or it may be connected to a larger Internet. Each computer system in a MANET is also referred to as a node or device. Each device may be equipped with a wireless transceiver using an antenna that may be omni-directional (broadcast), highly directional (point-to-point), steerable, or some combinations thereof.

An implicit assumption within the MANET is that every device within the network may wish to communicate with every other device within the network. The MANET protocol defines all devices as routers, and then goes about trying to comprehend how each router maintains real time knowledge about the existence of other routers within the network. This becomes an exponential task to manage as the network increases in size. This problem is compounded by the ability of the devices to dynamically enter or leave the network in an “ad hoc” fashion. The ad hoc nature of the network creates an onerous network management problem, flooding the network with status packages requiring constant updates.

There are a number of issues with MANET that need to be addressed. One issue is bandwidth. As devices enter, leave, and move around the MANET, the MANET is constantly changing. Requiring each device in the MANET to be aware of changes made by the entry, departure, or movement of a device would consume a great deal of the available bandwidth.

Another issue is power. Mobile computing systems typically rely on battery power. Since battery power is limited and communicating within the network is power-intensive, having each device update itself as another device enters, leaves, or moves with the MANET may consume a large percentage of the available power.

Another issue is complexity. As the number of devices in the MANET increases, the number of routes through the MANET increases exponentially. For even a relatively small number of devices (100 is typically considered a sizeable MANET), the time required to update a routing table for the MANET may take longer until another device enters, leaves, or moves within the MANET. In addition, the space requirements for storing the routing table may quickly exceed the available space in the device.

### BRIEF DESCRIPTION OF THE DRAWINGS

The following drawings disclose various embodiments of the present invention for purposes of illustration only and are not intended to limit the scope of the invention.

FIG. 1A illustrates an example of an arrangement of mobile ad-hoc network (MANET) devices.

FIG. 1B illustrates an example of a MANET established among the MANET devices of FIG. 1A.

FIG. 2 illustrates an example of a mobile device operable within a MANET.

FIG. 3A is a block diagram illustrating an example of a device providing storage services to other devices in a MANET sub-network.

FIG. 3B is a block diagram illustrating another example of multiple devices providing storage services to other devices in a sub-network.

FIG. 4 is a flow diagram illustrating one example of a process used to allow a device to provide storage service to other devices in a sub-network.

FIG. 5 illustrates an example of a device capable of sharing its processing capability.

FIG. 6A is a block diagram example illustrating a sub-network having a device sharing its processing unit.

FIG. 6B is a block diagram illustrating an example of a sub-network having multiple devices sharing their PUs.

FIG. 7 is a flow diagram illustrating one example of a process used to allow a device to provide storage service and processing service to other devices in the sub-network.

FIG. 8 illustrates an example of a device capable of sharing its I/O capability.

FIG. 9 is a block diagram example illustrating a sub-network having one or more devices sharing I/O units.

FIG. 10 illustrates an example of a device capable of sharing its I/O, storage, and processing capabilities.

FIG. 11A illustrates an example of a device capable of sharing its bridge/gateway (B/G) capability.

FIG. 11B illustrates an example of a device having a wireless access point and a B/G unit that provides connection to a wired network.

FIG. 12 is a block diagram example illustrating a sub-network having a device sharing its B/G capability with other devices in the sub-network.

### DETAILED DESCRIPTION

In accordance with one embodiment of the present invention, a method of extending a memory capability of a MANET device is disclosed. In accordance with another embodiment, a method of extending a processing capability of a MANET device is disclosed. Other embodiments are also disclosed.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

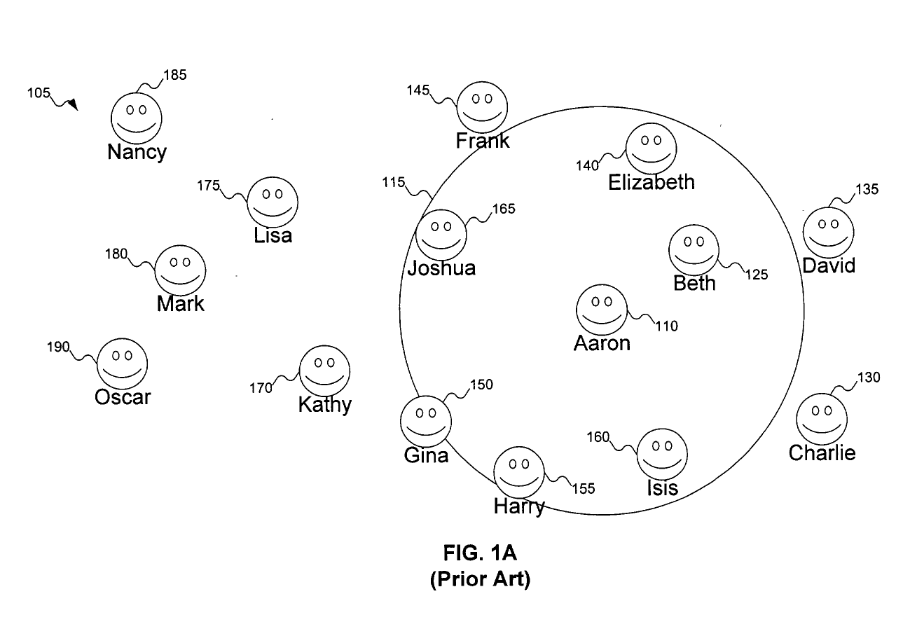

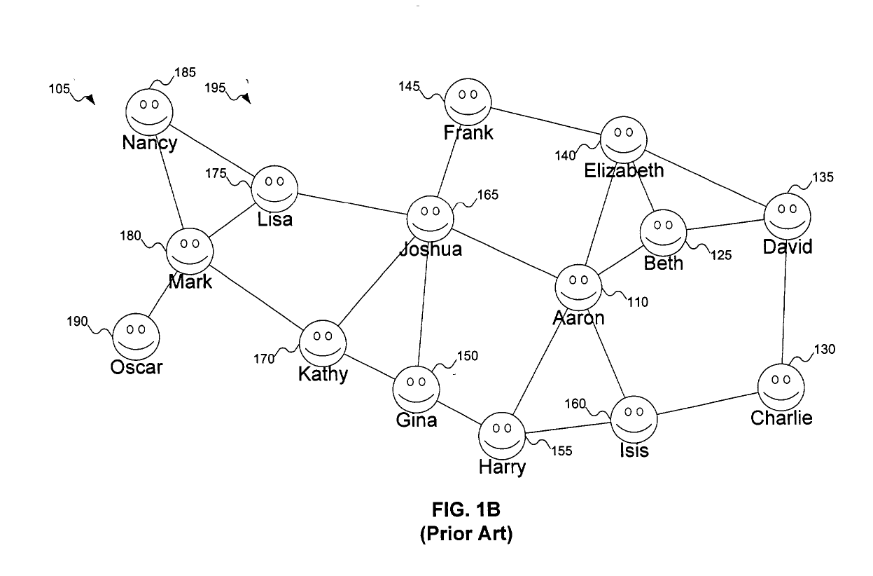

FIG. 1A illustrates an example of an arrangement of MANET devices. The MANET devices may be scattered over a general location. The location may be a mall, sporting arena, city, or any other type of location, without any limit. In the following description, a device in a MANET may be able to communicate directly with other devices within its range. Referring to FIG. 1A, each device is described to be associated with its user. For example, Aaron's device 110 may be able to communicate with Beth's device 125. Each device may have a limited range, and thus may not be able to directly communicate with every other device in the MANET 105. For example, Aaron's device 110 has a range 115 shown as a dashed circle, and because Beth's device 125 is within the communications range of Aaron's device 110, Aaron can communicate directly with Beth. Because Charlie's device 130 is not within the communications range of Aaron's device 110, Aaron cannot communicate directly with Charlie.

The intuitive approach for managing a MANET is to have each device be aware of all other devices in the MANET. FIG. 1B illustrates an example of a MANET established among the multiple MANET devices illustrated in FIG. 1A. As illustrated in FIG. 1B, Aaron's device 110 may communicate directly with Beth's device 125, Elizabeth's device 140, Harry's device 155, and Isis' device 160, but may not communicate directly with Charlie's device 130 or David's device 135. Nevertheless, Aaron's device 110 may communicate with Charlie's device 130 or David's device 135 through Beth's device 125 or Isis' device 160, respectively.

A device may be active in a MANET but may not be reachable by other devices. For example, given Oscar's location, Oscar's device 190 has a communication range that includes only Mark's device 180. Oscar's device 190 may communicate with other devices in the MANET 195 only through Mark's device 180. Similarly, other devices in the MANET 195 may be able to communicate with Oscar's device 190 through Mark's device 180. However, if Mark's device 180 leaves the network (e.g., by Mark turning off his device), Oscar's device 190 may neither send nor receive messages from any other devices in the MANET 195, even though Oscar's device 190 remains active. It should be noted that the devices in the MANET 195 may be heterogeneous devices. As can be seen, the MANET 195 may be considered an infinite network because there is no limit to the number of devices that can join. Furthermore, the MANET 195 dynamically changes as devices join, leave, or move to different places, making it difficult to manage.

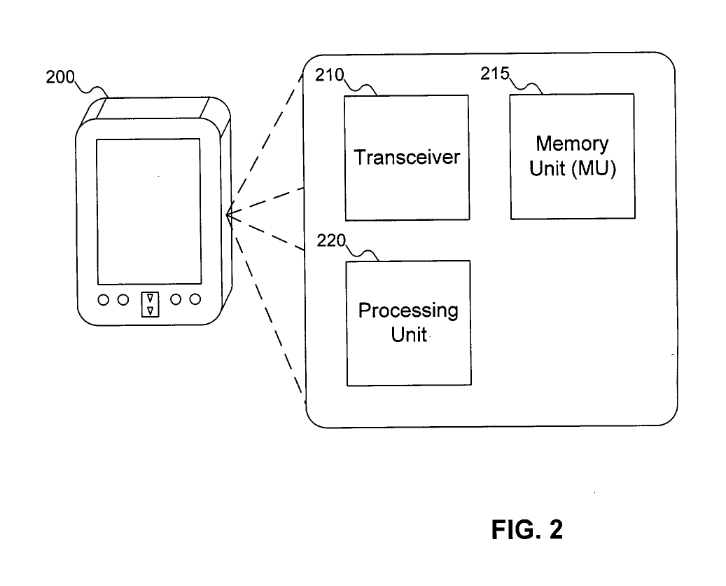

FIG. 2 illustrates an example of a device operable within a MANET. Device 205 may be a mobile device and may be used to communicate with other devices in the MANET 195. Although shown as a personal digital assistant (PDA), one skilled in the art will recognize that the device 205 may be any device capable of communicating with nearby devices using, for example, a wireless communication link. For example, the device 205 may be a cellular telephone or notebook computer configured to communicate with the nearby devices. Although the device 205 is being described as a mobile device, the device 205 may not need to be truly mobile.

The device 205 may include, among other components, a wireless transceiver 210, a microprocessor 220, and a memory unit (MU) 215. The device 205 may be capable of executing applications stored in the MU 215. The transceiver 210 may be used to receive communications from other nearby devices. The transceiver 210 may also be used to transmit communications to other nearby devices. In one embodiment, the transceiver 210 may operate using a wireless communication protocol. The microprocessor 220 is used to control the internal operations of device 205. The MU 215 may be used to store information (e.g., temporary, semi-permanent nature, etc.) within the device 205. The MU 215 may include a memory controller and one or more memory devices. The MU 215 may store application software (not shown) such as, for example, word processing software, game software, etc. As the device 205 enters the MANET 195, the device 205 may need to inform other nearby devices of its existence by establishing communications with the nearby devices.

The device 205 may also need to store, for example, a list of the nearby devices (not shown) in the MU 215. This list may be referred to as a contact list. The list of nearby devices may include devices that the device 205 communicates with. In one embodiment, a device may communicate only with devices that share similar attributes. Devices having similar attributes may together form a sub-network within a larger MANET. A sub-network may be viewed as an association, and the members of the association may include the devices 205 and other nearby devices that share similar attributes. For example, employees of a company share the same attribute where the company is considered to be the association that the employees belong to.

Devices in a sub-network may provide specialized services to other devices in the sub-network. For example, a device within the sub-network may share its storage capacity, processing capacity, input/output capacity, etc., individually or in combinations.

Referring to FIG. 2, the device 205 may provide specialized services to the other devices in the MANET 195. In one embodiment, the device 205 may allow the other devices to access the MU 215 to remotely store or retrieve data. This may be advantageous for the other devices because their power consumption may be reduced, for example, by supporting fewer components. Another advantage to being able to access the MU 215 for the other devices is the lower memory requirements for the other devices, which may result in the devices being smaller in size.

In one embodiment, the device 205 may place restrictions on the data stored in the MU 215. For example, the restrictions may include requiring access authorization when a device accesses the MU 215. This may allow the device 205 to store secured data from secure applications such as, for example, insurance, banking, etc., in the MU 215. In another embodiment, the device 205 may be able to provide the specialized services only when it is able to do so. For example, when there is redundant storage in the MU 215, the device 205 may allow the other devices to store their data in the MU 215.

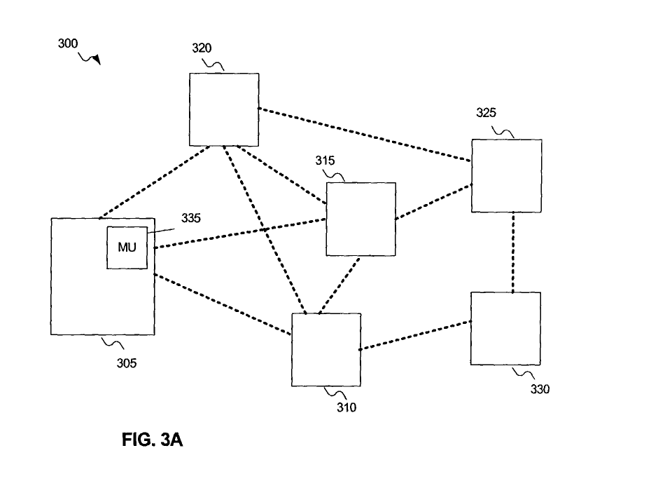

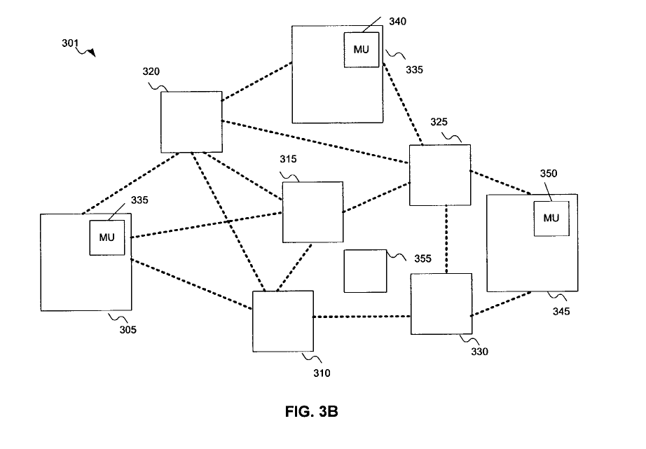

FIG. 3A is a block diagram illustrating an example of a device providing storage services to other devices in a sub-network. The devices illustrated in FIG. 3A may belong to the sub-network 300. Some of these devices may communicate directly with one another (e.g., within range) or they may communicate indirectly with one another (e.g., using another device when not within range). For example, the device 305 may communicate directly with the device 315, but it may communicate indirectly with the device 325 using the device 315. Similarly, the device 325 may communicate indirectly with the device 305 using the device 315, or the devices 330 and 310, or the devices 315 and 310, or the device 320, etc. The device 305 may provide storage services via its MU 335 to the other devices 310-330.

In this example, the MU 335 of the device 305 may be used to store climate data for a climate application. In one embodiment, to secure the climate data stored in the MU 335, the devices 310-330 may need to be authenticated before they can be granted access to the MU 335. In another embodiment, all devices in the sub-network 300 may need to be authenticated to participate in communications within the sub-network 300.

Each of the devices 310-330 may independently collect climate data from its local location and store the climate data in the MU 335 forming an aggregated climate database. The aggregated climate database may then be accessed by another device for analysis. For example, a user using the device 315 may access the aggregated climate database stored in the MU 335 to evaluate and predict future climate patterns.

FIG. 3B is a block diagram illustrating another example of multiple devices providing storage services to other devices in a sub-network. The sub-network 301 illustrated in FIG. 3B is similar to the sub-network 300 illustrated in FIG. 3A with the addition of the devices 335 and 345. The sub-network 301 does not include device 355 even though the device 355 may be inside the ranges of, for example, the device 330 and the device 310. This is because, in this example, the device 355 does not share the same attributes with the other devices in the sub-network 301 and therefore does not belong to the same association.

In one embodiment, there may be multiple devices in the sub-network 301 that provide storage services to the other devices. For example, each of the devices 305, 335, and 345 may provide storage services to the devices 310-330. Having multiple devices each providing storage services to the sub-network 301 may be advantageous in an environment where a large memory capability is required, in an environment where each of these devices provides storage services to a specific application, etc., individually or in combination. In one embodiment, the MUs 305, 335, and 345 may be logically aggregated to provide a greater storage capability for the devices 310-330. In another embodiment, the MUs 305 and 335 may be used as redundant storage for the MU 345 such that, for example, if the MU 345 is disabled, the MUs 305 and 335, individually or in combination, may be used to store or to retrieve data.

Referring to FIG. 3B, each pair of devices in the sub-network 301 may independently determine the communication protocol used to exchange information between them. This may include, for example, latency or speed of delivery, buffering information, error correction information, etc. Each device may interrogate its counterpart device to gather information used to establish the communication. For example, the communication established between the device 310 and the device 330 may be based on 802.11b, while the communication established between the device 310 and the device 315 may be based on 802.11a. In one embodiment, the information used for communication between two devices may be different at different times. For example, the buffering information may be changed to increase performance. In one embodiment, a device may be equipped with a dual mode communication capability (e.g., 802.11a and 802.11b). When two dual mode devices communicate with one another, it may be possible that the two devices may initially negotiate to exchange information using 802.11b, but may subsequently renegotiate to exchange information using 802.11a, for example.

In one embodiment, it may be necessary for two devices to periodically synchronize with one another. Synchronization may include, for example, resetting their mutual clocks and determining if there is any information or network updates to be passed between the two devices. It may not be necessary that all of the devices in the sub-network 301 synchronize with each other at the same time period. That is, different pair of devices may have different periods for synchronization. For example, the device 310 may synchronize with the device 330 every 30 minutes, while the device 310 may synchronize with the device 315 every 10 minutes.

When synchronization occurs, in addition to the devices sharing with each other information about itself, the devices may share with each other knowledge about other devices. In one embodiment, the device only shares knowledge about other devices that have the same association. For example, the device 310 may share its knowledge about the device 305 with the device 330, including the storage capability of the device 305 because the devices 305, 310 and 330 have the same association. On the other hand, because the device 355 is not in the same association with the device 305, the sharing of information between the device 310 and the device 355 does not include knowledge about the device 305. For one embodiment, the synchronization and the transferring of data between devices may be performed using the methods and apparatuses described in U.S. application Ser. No. 09/035,896 filed on Oct. 18, 2001 titled “METHOD FOR DISCOVERY AND ROUTING WITHIN MOBILE AD-HOC NETWORKS” and assigned to the assignee of the present application.

In one embodiment, each device in the sub-network is assigned to a device that is capable of sharing its storage capability. For example, referring to FIG. 3B, the device 330 may be assigned to use the storage capability of the device 345, and the device 310 may be assigned to use the storage capability of the device 305. In this situation, when the device 345 is inactive or absent, the device 330 may not be able to use any storage services offered by any other devices, including the device 305. Furthermore, because the device 330 may be moved to a different location, the number of hops between the device 330 and the device 345 may vary from time to time. In this example, the device 330 may need to be able to accept that the device 345 may not always be active or present, and as a result the data stored in the MU 350 of the device 345 may not always be available.

In another embodiment, a device is dynamically assigned to a closest device that offers storage services. For example, the device 330 may initially be assigned to use the storage service of the device 345. However, when the device 330 is relocated to a location that is closer to the device 305 as compared the distance to the device 345, the device 330 is dynamically assigned to the device 305. As described above, the device 305, 330 and 345 have the same association. In this example, the device 330 may need to keep track of the data it stores in the MU 350 of the device 345, and the data it stores in the MU 335 of the device 305.

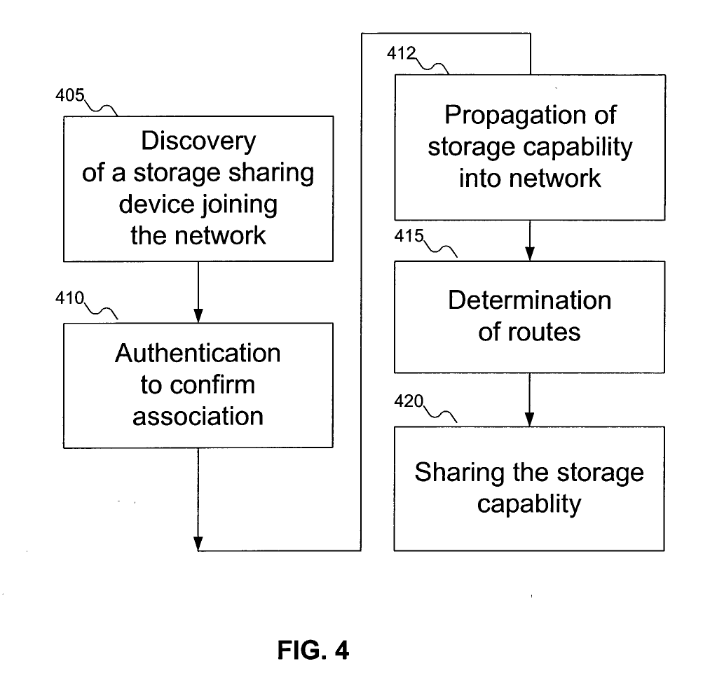

FIG. 4 is a flow diagram illustrating one example of a process used to allow a device to provide storage service to other devices in a sub-network. At block 405, a new device joins the network. To enter the network, the new device may need to be active or powered-on. In this example, the new device includes an MU and is capable of sharing its memory capacity to other devices. The new device may need to perform discovery operations to identify its neighboring or nearby devices. Similarly, other devices near the new device may also need to perform discovery operations to discover the new device. This process may be performed periodically to keep track of presence or absence of nearby devices and to update the routing table within each device.

A device may be physically nearby but may not share the same mutual association with the new device. Authentication operations may need to be performed to verify or confirm the mutual association, as shown in block 410. For example, the association may include members that perform climate data gathering for climate analysis and predictions.

When the new device is authenticated to have the same mutual association with the other devices, the new device exchanges its knowledge of storage capability with the nearby devices (within range) that have the mutual association, as shown in block 412. Knowledge of the storage capability of the new device may be propagated across the network, via iterative and frequent exchanges of the knowledge of the devices that share the mutual association to get to non-nearby devices (not within range). Other information may also be exchanged among the devices. For example, they may exchange knowledge of other devices within their respective routing tables that share the mutual association, including knowledge about those devices' storage capabilities.

At block 415, route determination operations between devices are performed. A device that is in the same association with the new device may be located within the range of the new device. In this situation, the route between the devices may be simple and may be direct between two devices. Alternatively, a device may be in the same association with the new device but may not be located within the range of the new device. In this situation, the route between this out-of-range device and the new device may need to go through one or more intermediary devices, at least one of which needs to be within the range of the new device. For one embodiment, the association may assign one or more devices to use the storage capability of the new device. Alternatively, the assignment of a device to the new device may be performed dynamically based on, for example, lowest cost routing.

At block 420, the storage unit of the new device may be shared or used by the other devices that have the same mutual association.

As described above, the new device and its nearby devices may communicate with one another to determine, for example, a mutually acceptable synchronization period with corresponding frequency hopping pattern, direct sequence spreading codes, form of communication protocol, etc. During the period that a device that shares its MU is active in the sub-network, that device and its nearby devices may each update their respective routing tables with any changes in the network including, for example, addition of devices, subtraction of device, routing hop distance changes based upon a cost-based algorithm, etc. The information/status transferred between devices may be scheduled and delivered based upon the mutual determination of the two devices that form each device pair. For example, the information may include the latency or speed of delivery, buffering information, error correction information, connection information (e.g., connection-oriented or connection-less service) is determined by the device pairs at their initial interrogation, and may have been subsequently revised based on changing device or network status. The frequent updates performed by all of the devices in the association enable the devices to detect absence of one or more devices from the sub-network. The detection of absence of a prior device may then be propagated across the sub-network.

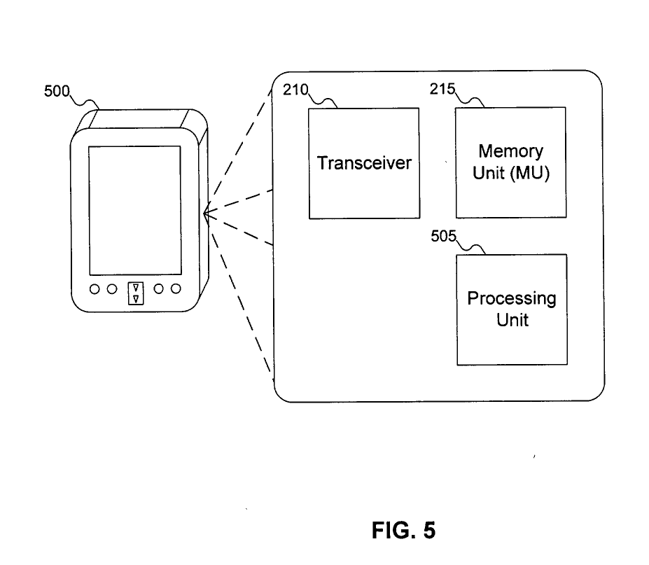

In one embodiment, a device in a sub-network may be able to share its processing capability with other nearby devices having the same association. This may also be in addition to sharing its storage capability. FIG. 5 illustrates an example of a device capable of sharing its processing capability. Referring to FIG. 5, the device 500 includes a processing unit (PU) 505. The PU 505 may be a general system processor (e.g., a central processing unit (CPU)) or a functional-specific processor (e.g., a graphics processor, a floating point processor, etc.). The processing capability of the PU 505 may be shared with other devices to enable the other devices to perform remote computational tasks, for example. Being able to share another device's processing unit allows the devices to reduce their power consumption because the power intensive work is performed elsewhere. Being able to share another device's processing unit also allows the devices to require less processing capability. There may also be many other advantages. In one example, when the PU 505 is shared, the other devices in the same sub-network to be smaller in size while still providing processing capability similar to larger devices.

In one embodiment, the device 500 may place restrictions on tasks from other devices to be processed by the PU 505. In one example, the PU 505 may only be shared to process tasks that relate to a particular application (e.g., secure insurance or banking applications, etc.). In another example, the PU 505 may only perform tasks from other devices based upon very specific processing capabilities (e.g., floating point operations, etc.).

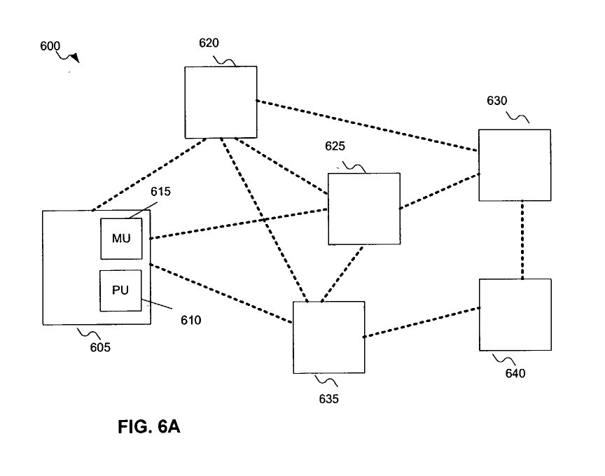

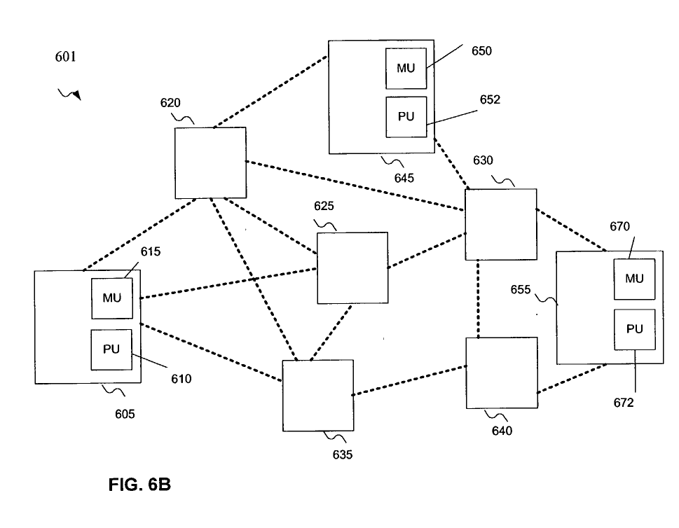

FIG. 6A is a block diagram example illustrating a sub-network having a device sharing its processing unit. In this example, all of the devices in the sub-network 600 have similar attributes, including the device 605. The device 605 is authenticated on the network like the other individual devices. The device 605 includes the MU 615 and the PU 610, and may share these with the other devices in the sub-network 600. The devices 620, 625, and 635 are able to communicate with the device 605 directly. The devices 630 and 640 may communicate with the device 605 via the intermediate devices. There may be several routes for the devices 630 and 640 to communicate with the device 605.

The device 605 may share its PU 610 with the devices 620-640 to perform tasks on behalf of the devices 620-640. For example, the devices 605 and 620-640 may be participating in a wireless game. All of the devices are within an authenticated gaming network and may be simultaneously playing the same game. All of the devices may be simultaneously communicating with the device 605 and its PU 610. The PU 610 may be running a game algorithm. The game algorithm may be a complex task that integrates all the inbound-data (received from each of the devices), processes the data, and replies with outbound-data (specific to each device receiving a response).

In one embodiment, there may be multiple devices in a sub-network that are capable of sharing the capacity of their PUs. FIG. 6B is a block diagram illustrating an example of a sub-network having multiple devices sharing their PUs. In this example, the devices 605, 645, and 655 in the sub-network 600 may share their PUs with the devices 620-640. This may be useful in environments where multi-processing capabilities are required (e.g., the multiple PUs may be used to achieve a greater processing capability in aggregate), or it may be useful in environments where specialized functions are more efficiently maintained as separate functional devices (e.g., each of the PUs may perform different, specialized functions), or some combination of both.

A device may be capable of sharing both its MU and its PU. For example, referring to FIG. 6B, the device 605 may share its MU 615 and its PU 610 to other devices. One or more of these other devices may use the PU 610 to remotely perform computational tasks. Similarly, one or more of these other devices may use the MU 615 to remotely store data. That is, these other devices can offload their memory requirement and their processing requirement to the device 605 allowing them to operate as if they were equipped with much more storage and processing capacities. This makes these other devices less costly to manufacture and therefore more affordable to consumers.

The device 605 may place restrictions on the other devices in sharing its MU 615 and its PU 610, as described above. Each of the devices 605, 645, and 655 may share both of its PU and MU, only its MU, or only its PU. With multiple devices sharing one or more of their PUs and MUs, it may be possible to have a multi-processing application environment where multi-processing capabilities (e.g., an aggregate of processing capabilities) and large storage capabilities (e.g., an aggregate of storage capabilities) are required. For example, one environment may be a financial service environment where the volume of traffic, complexity of real-time computational transactions and the amount of storage required are all very high and can only be achieved in aggregate.

Data communicated between any two devices in the sub-network traverses the wireless network, using the routing methods described above. On a packet-by-packet basis the individual devices may determine the most appropriate path through the network. For example, the path may be determined based upon various least-cost metrics described in the related applications. The individual devices may react dynamically to real-time changes to the networks. For example, referring to the wireless gaming example illustrated in FIG. 6A, if the device 635 is turned off, then the remaining devices may dynamically update their routing tables to reflect this change. In addition, data paths may be changed and the different routes may need to be taken to exchange data between devices. For example, without the device 635, the device 640 may need to take a longer route via the devices 630 and 625 to reach the device 605. In one embodiment, when the routing tables are dynamically updated to reflect changes, least-cost routing strategies are used.

The processing and memory requirements of each device in a sub-network may not need to be evenly balanced within a specific device. For example, intensive transaction processing may be paired with minimal caching capabilities; limited transaction processing may be paired with huge amounts of easily accessible mass storage; intensive transaction processing may be paired with no caching capabilities; no transaction processing may be paired with huge amounts of easily accessible mass storage. It may be possible that there may be multiple devices competing for the same processing services and storage services, these devices may need to cooperate with one another to utilize these services. This may include, for example, having to wait in a queue to use a processing service or a storage service while another device is being serviced.

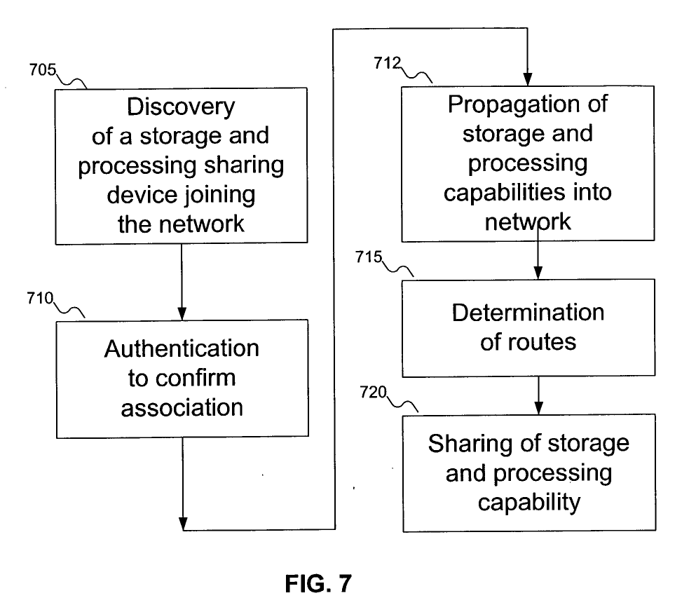

FIG. 7 is a flow diagram illustrating one example of a process used to allow a device to provide storage service and processing service to other devices in the sub-network. A similar process may also be used to provide only the processing service to other devices in the sub-network. At block 705, a new device joins the network. In this example, the new device includes a PU and is capable of sharing its processing capacity to other devices. The new device may need to perform discovery operations to identify its neighboring or nearby devices. Similarly, other devices near the new device may also need to perform discovery operations to discover the new device. This process may be performed periodically to keep track of presence or absence of nearby devices and to update the routing table within each device. The discovery process may include synchronization and other operations, as described above.

At block 710, authentication operations may need to be performed to verify or confirm the association of the new device with other devices. Security protocols may need to be set up to protect data exchanged between devices.

At block 712, the new device exchanges its processing capability and storage capability with the nearby devices that have mutual association. Knowledge of the processing capability and storage capability of the new device may then be propagated across the sub-network to other devices, via iterative and frequent exchanges of the knowledge of the devices that share the mutual association. Other information may also be exchanged among the devices. For example, they may exchange knowledge of other devices within their respective routing tables that share the mutual association, including knowledge about those devices' processing capabilities and storage capabilities.

At block 715, route determination operations between devices are performed. A route between two devices may be a direct route that uses no intermediary device. Alternatively, a route between two devices may be an indirect route that uses one or more intermediary devices. It may be noted that any device in a sub-network may be used as an intermediary device for the purpose of routing information.

At block 720, the processing capability and the storage capability of the new device may be used by the other devices that have the same association.

During the period that a device that shares its PU and MU is active in the sub-network, that device and its nearby devices may each update their respective routing tables with any changes in the network including, for example, addition of devices, subtraction of device, routing hop distance changes based upon a cost-based algorithm, etc. The information/status transferred between devices may be scheduled and delivered based upon the mutual determination of the two devices that form each device pair. For example, the transfer may be performed periodically when synchronization occurs. The information transferred may include, for example, the latency or speed of delivery, buffering information, error correction information, connection information (e.g., connection-oriented or connection-less service) is determined by the device pairs at their initial interrogation, and may have been subsequently revised based on changing device or network status. The frequent updates performed by all of the devices in the association enable the devices to detect absence of one or more devices from the sub-network. The detection of absence of a prior device may then be propagated across the sub-network.

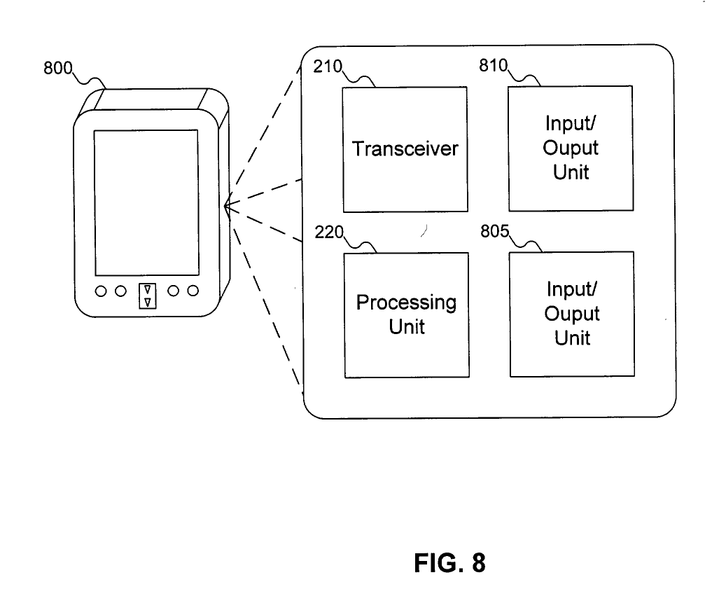

A device may include an input/output (I/O) capability and may share that capability with other devices having the same association. The device may also share one or more of its storage capability and processing capability in addition to sharing the I/O capability. FIG. 8 illustrates an example of a device capable of sharing its I/O capability. Referring to FIG. 8, the device 800 may include one or more I/O units, in this example, I/O units 805 and 810. An I/O unit may be an input unit, an output unit, or a combination of both. Examples of an input unit may include, a keyboard, a mouse, a touch screen, a sensor, a receiver, etc. Examples of an output unit may include a display, a printer, a transmitter, a fax machine, an audio speaker, etc. The I/O capability of the device 800 may be shared with other devices to enable the other devices to perform remote I/O tasks, for example. Being able to share another device's I/O capability allows the devices to reduce their power consumption, to improve function usage for the devices, and reduce their complexity.

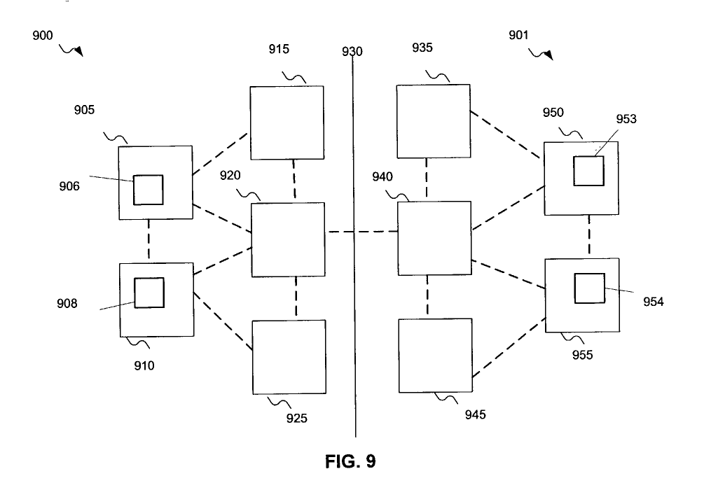

FIG. 9 is a block diagram example illustrating a sub-network having one or more devices sharing I/O units. In this example, there are two sub-networks 900 and 901. All of the devices 905-925 in the sub-network 900 may, have similar attributes. For example, the devices 905-925 may be participating in a first presentation in a first conference room. The devices 905-925 are authenticated on the sub-network 900. Similarly, all of the devices 935-955 in the sub-network 901 may have similar attributes. For example, the devices 935-955 may be participating in a second presentation in a second conference room. The two conference rooms in this example may be separated by a wall 930. Referring to the sub-network 901, the devices 905 and 910 may share their I/O units to the other devices in the sub-network 901. For example, the device 905 may share its audio speakers I/O unit 906, and the device 910 may share its display I/O unit 908. The audio speakers I/O unit 906 and the display I/O unit 908 may respectively be sufficiently loud and large enough to allow users of the other devices in the first conference room to share hearing and viewing the first presentation. Although not shown, the devices 915-925 may also share their I/O capabilities to the sub-network 900. Furthermore, the first conference room may have many more devices, and as such, communication from these devices to the devices 905 and 910 may be direct or indirect (e.g., through intermediary devices).

Referring to the sub-network 901, the devices 950 and 955 may share their I/O units to the other devices in the sub-network 901. For example, the device 950 may share its audio speakers I/O unit 953, and the device 955 may share its display I/O unit 954. The devices in the two sub-networks 900 and 901 may have a common association. For example, although the two presentations may be different, the users of the devices 905-955 may belong to the same department and therefore the devices 905-955 may form a larger sub-network. For example, there may be a third presentation that requires participation from all of the devices 905-955. Using shared I/O capability, the third presentation may be conducted without having to move to a larger conference room. For example, a presentation presented by a user of the device 925 (e.g., a PDA) may remotely use the speakers I/O of the devices 905 and 950 and the display I/O of the devices 910 and 955. As described above, the devices in the sub-networks need to dynamically update their routing tables at synchronization time to reflect absences, presences or locations of other devices. For example, when an user walks or moves to a device that shares its display I/O capability to make a presentation using information from the user's own device, routing tables from the other devices need to be updated to reflect this movement using, for example, least cost routing strategies (e.g., fewest number of hops, latency, bandwidth availability, quality of service, etc.).

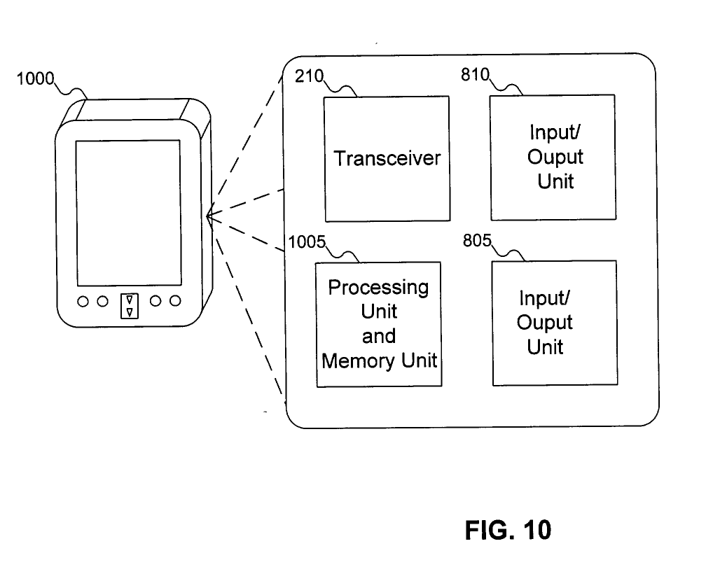

In one embodiment, a device may share one or more of its I/O capability, MU capability, and PU capability to other devices in its sub-network. FIG. 10 illustrates an example of a device capable of sharing its I/O, storage, and processing capabilities. Device 1000 includes I/O units 805, 810, PU and MU 1005. The sharing services provided by the device 1000 may enable other devices to reduce power consumption, to be less complex and less costly to be manufactured. For example, the device 1000 may be a laptop computer equipped with a large display, high capacity disk drive, and a fast processor while the other devices sharing its services may be smaller devices such as PDAs.

When a new device capable of sharing one or more of its I/O capacity, storage capacity, and processing capacity becomes active, that device needs to go though a process similar to the process described in FIG. 7. This includes, for example, going through the discovery and authentication operations, the route determination operations, and the sharing operations including sharing the I/O capacity. Other operations may include dynamically updating itself with knowledge propagated by other devices, sharing its knowledge with other devices, and updating its routing table based on the dynamic of the network, etc.

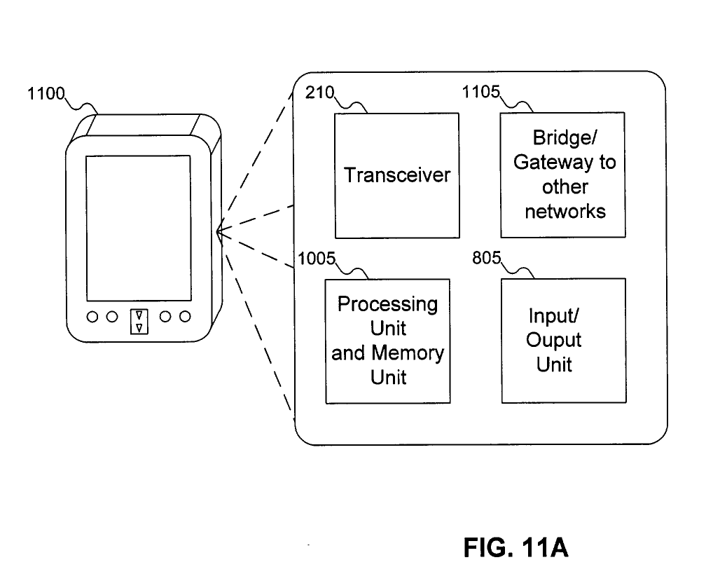

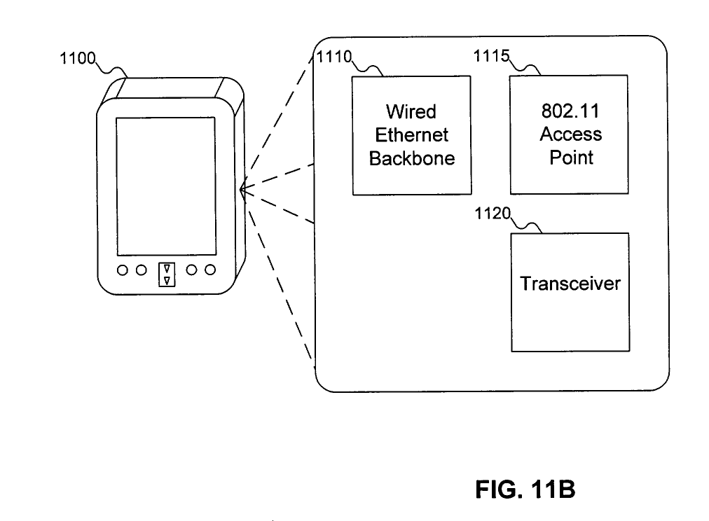

A device may include a bridge/gateway (B/G) capability and may share that capability with other devices having the same association. The device may also share one or more of its I/O capability, storage capability and processing capability in addition to sharing the B/G capability. FIG. 11A illustrates an example of a device capable of sharing its B/G capability. Device 1100 may include B/W unit 1105. The device 1100 may also include the I/O unit 805 and the PU and MU 1005. A device may have multiple B/G units. The B/G unit 1105 may allow a device to span two or more similar or dissimilar wired or wireless networks where devices connected to these networks have the same association. A wireless ad hoc device may communicate with a wired device having the same association via the device 1000 using the B/G unit 1105. For example, the device 1000 may be used to allow a device in a sub-network of ad hoc devices to connect to an Ethernet network. The device 1000 may also include an access point (e.g., 802.11 access point) to allow connection by other wireless devices. FIG. 11B illustrates an example of a device having an 802.11 access point 1115, an ad hoc network wireless transceiver 1120, and a B/G unit 1110 that connects to a wired Ethernet network.

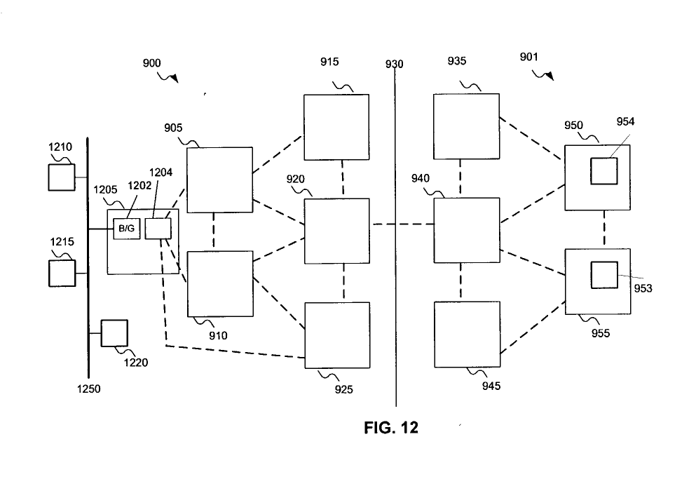

FIG. 12 is a block diagram example illustrating a sub-network having a device sharing its B/G capability with other devices in the sub-network. The sub-networks illustrated in this example are similar to the sub-networks illustrated in FIG. 9, with the addition of device 1205 and devices 1210-1220 connected to a wired network 1250. The device 1205 includes a B/G unit 1202 to allow connection to a first wired network 1250. The device 1205 also includes a transceiver 1204 to allow connection to wireless ad hoc devices 905-955. Although not shown, the device 1205 may also include additional B/G units to connect to other wired networks. In this example, it is assumed that all of the devices shown have the same association and therefore can communicate and exchange data with one another. As described above, in order to participate in the network, a device needs to be active and to performs operations almost similar to the operations described in FIG. 7 before the device begin to share its B/G capability. For example, the device needs to go through the discovery and authentication process, to dynamically update itself with knowledge propagated by other devices, to share its knowledge with other devices, to update its routing table based on the dynamic of the network, etc. When a new device having a B/G capability to allow connection with both the wireless network and the wired network becomes active, knowledge of its presence may be propagated across the network, and accordingly routing tables of some devices may be updated to reflect this addition.

The operations of these various methods may be implemented by a processor in a computer system (or device), which executes sequences of computer program instructions which are stored in a memory which may be considered to be a machine-readable storage media. For example, the computer system may be the device 205 illustrated in FIG. 2. The memory may be random access memory (RAM), read only memory (ROM), a persistent storage memory, such as mass storage device or any combination of these devices. Execution of the sequences of instruction causes the processor to perform operations according to one embodiment the present invention such as, for example, the operations described in FIG. 4 or FIG. 7.

Methods and apparatuses for sharing or providing one or more of storage capability and processing capability in a mobile ad-hoc wireless network (MANET) have been disclosed. The methods enable devices to offload activities to other devices in the network having the same association and thereby may allow the devices to consume less power (e.g., battery-powered devices), have smaller form factors and lower manufacturing cost, etc.

Although the present invention has been described with reference to specific exemplary embodiments, it will be evident that various modifications and changes may be made to these embodiments without departing from the broader spirit and scope of the invention as set forth in the claims. For example, although the embodiments described above refer to transmitting high-level commands, the embodiments may also be used to transmit low-level bit streams. Accordingly, the specification and drawings are to be regarded in an illustrative rather than a restrictive sense.

What is claimed is:

1. A device, comprising:
a transceiver to enable wireless communication with one or more other devices in a mobile network which share a common association, wherein the wireless communication allows for usage of one or more services provided by the one or more other devices, and wherein routes among the one or more other devices are dynamically updated to reflect changes in the network.

2. The device of claim 1, wherein the wireless communication further allows for authentication of the device in the network.

3. The device of claim 1, wherein the wireless communication further allows for propagation of knowledge of the one or more services provided by the one or more other devices across the network.

4. The device of claim 1, wherein the routes are dynamically updated based on least cost routing.

5. The device of claim 1, wherein the changes in the network include insertion, removal and relocation of the one or more other devices.

6. The device of claim 1, wherein the one or more services include storage service, processing service, input and output service, and bridge and gateway service.

7. A device comprising:
a transceiver to enable providing one or more services to one or more other devices in a wireless network, to enable authenticating the one or more other devices as having a common association, and to enable propagating knowledge about the one or more other devices across the wireless network.

8. The device of claim 7, wherein the knowledge about the one or more other devices include services provided by the one or more other devices.

9. The device of claim 7, wherein the one or more services provided to the one or more other devices include processing service to perform one or more tasks on behalf of the one or more other devices.

10. The device of claim 7, wherein the one or more services provided to the one or more other devices include storage service to store data on behalf of the one or more other devices.

11. The device of claim 7, wherein the one or more services provided to the one or more other devices include input/output (I/O) service to perform I/O operations on behalf of the one or more other devices.

12. The device of claim 7, wherein the one or more services provided to the one or more other devices include bridge/gateway service to allow the one or more other devices to exchange data with a device connected to a wired network.

13. The device of claim 7, wherein the transceiver is further to enable dynamic updating of routes to the one or more other devices to reflect changes in the network.

14. The device of claim 13, wherein the routes are dynamically updated based on least cost routing.

15. The device of claim 14, wherein the routes are dynamically updated per synchronization period.

16. A method, comprising:
discovering nearby devices in a wireless network;
performing authentication with the nearby devices;
propagating knowledge of services provided by the nearby devices; and
using the services provided by the nearby devices.

17. The method of claim 16, wherein performing authentication with the nearby devices comprises verifying that the nearby devices have a common association.

18. The method of claim 17, wherein the nearby devices are devices positioned within a wireless communication range, and wherein the knowledge of the services provided by the nearby devices are propagated to other devices positioned inside and outside the a wireless communication range that have the common association.

19. The method of claim 16, further comprising:
determining routes to the nearby devices.

20. The method of claim 19, wherein determining the routes to the nearby devices comprises:
determining a synchronization period with each of the nearby devices; and
dynamically performing route updates at each synchronization period to reflect changes to the network that occur since a previous synchronization.

21. The method of claim 20, wherein the changes to the network include changes to positions of the nearby devices, changes to a number of nearby devices, and changes to the services provided by the nearby devices.

22. The method of claim 16, further comprising:
exchanging knowledge of services provided with the nearby devices.

23. An article of manufacture, comprising:
a machine-accessible medium including data that, when accessed by a machine, cause the machine to performs operations comprising:
discovering nearby devices in a wireless network;
performing authentication with the nearby devices;
propagating knowledge of services provided by the nearby devices; and
using the services provided by the nearby devices.

24. The article of manufacture of claim 23, wherein performing authentication with the nearby devices comprises verifying that the nearby devices have a common association.

25. The article of manufacture of claim 24, wherein the nearby devices are devices positioned within a wireless communication range, and wherein the knowledge of the services provided by the nearby devices are propagated to other devices that have the common association and that are positioned inside and outside the wireless communication range

26. The article of manufacture of claim 23, further comprising:
determining routes to the nearby devices.

27. The article of manufacture of claim 26, wherein determining the routes to the nearby devices comprises:
determining a synchronization period with each of the nearby devices; and
dynamically performing route updates at each synchronization period to reflect changes to the network that occur since a previous synchronization.

28. The article of manufacture of claim 27, wherein the changes to the network include changes to positions of the nearby devices, changes to a number of nearby devices, and changes to the services provided by the nearby devices.

29. The article of manufacture of claim 23, further comprising:
exchanging knowledge of services provided with the nearby devices.

30. A method, comprising propagating knowledge of services provided by one or more devices that have been discovered and authenticated to share a common association in a wireless network, wherein routes to the discovered devices are dynamically updated.

31. The method of claim 30, further comprising:
determining the routes to the discovered devices;
determining a synchronization period with each of the discovered devices; and
exchanging knowledge of services provided with the discovered devices.

32. The method of claim 31, wherein the routes to the discovered devices are dynamically updated at each synchronization period.

33. The method of claim 30, further comprising using the services provided by the discovered devices.

34. The method of claim 30, wherein the services include processing service, storage service, bridge and gateway service, and input and output service.
